(19) United States
(12) Patent Application Publication
(10) Pub. No.: US 2020/0398477 A1
(43) Pub. Date: Dec. 24, 2020

(54) 3D PRINTING OF INORGANIC MATERIAL IN ROUND INKJET PRINTING CONFIGURATION

(71) Applicant: XJET LTD., Rehovot (IL)

(72) Inventors: ELI KRITCHMAN, Rehovot (IL); IGAL ZEITUN, Rehovot (IL); MOSHE KOREN, Rehovot (IL); NADAV MORDECHAI, Rehovot (IL); NIR SADE, Rehovot (IL); MOSHE MANOR, Rehovot (IL)

(73) Assignee: XJET LTD., Rehovot (IL)

(21) Appl. No.: 16/975,011

(22) PCT Filed: Feb. 22, 2019
(86) PCT No.: PCT/IB2019/000191

§ 371 Date: Aug. 21, 2020

Related U.S. Application Data
(60) Provisional application No. 62/634,301, filed on Feb. 23, 2018.

(51) Int. Cl. B29C 64/112; B33Y 10/00; B33Y 30/00; B33Y 50/02; B22F 3/00; B28B 1/00; B28B 17/00; B29C 64/188; B29C 64/295; B29C 64/35; B33Y 40/00; B29C 64/241

(52) U.S. Cl. CPC B29C 64/112; B33Y 10/00; B33Y 30/00; B33Y 50/02; B22F 3/008; B29C 64/241; B28B 17/0081; B29C 64/188; B29C 64/295; B29C 64/35; B33Y 40/00; B28B 1/001

(57) ABSTRACT

An apparatus and methods of additive manufacturing are provided. The apparatus may include at least one frame for supporting at least one print head configured to deposit fluidic additive manufacturing material layer by layer, at least one reservoir in communication with the at least one print head, the at least one reservoir being configured to contain the additive manufacturing material, a printing table including at least one printing region for supporting at least one removable substrate for printing at least one three-dimensional object, the at least one removable substrate is made from a material other than the additive manufacturing material, and at least one processor configured to: control a rotational movement between the at least one print head and the printing table; and control vertical movement between the at least one print head and the printing table.

### PRIORITY CLAIM

This application claims priority to U.S. Provisional Application No. 62/634,301, filed Feb. 23, 2018, which is hereby incorporated by reference in its entirety.

### BACKGROUND

### Technical Field

The present disclosure relates to three-dimensional printing systems and, more particularly, to systems, devices, and methods printing three-dimensional objects using inkjet technology.

### Background Description

Three-dimensional printing is a process of making an object from a digital model. The process, which is also known as an “additive manufacturing” process, includes laying down successive layers of material until the object is created. One three-dimensional printing approach uses inkjet technology. In this approach, a three-dimensional inkjet printer dispenses a customized ink with micro particles of object material from print heads to construct the object layer-by-layer. However, traditional inkjet 3D printing may have a low production throughput. Accordingly, there exists a need for improved inkjet 3D printing techniques.

### SUMMARY

Embodiments of the present disclosure provide an additive manufacturing apparatus having a round printing configuration. The apparatus may include at least one frame for supporting at least one print head configured to deposit fluidic additive manufacturing material layer by layer, at least one reservoir in communication with the at least one print head, the at least one reservoir being configured to contain the additive manufacturing material, a printing table including at least one printing region for supporting at least one removable substrate for printing at least one three-dimensional object. The at least one removable substrate is made from a material other than the additive manufacturing material. The apparatus may include at least one processor configured to control a rotational movement between the at least one print head and the printing table and control vertical movement between the at least one print head and the printing table.

In some embodiments, the apparatus may include at least one movable printing platform on the printing table for supporting the at least one three-dimensional object, wherein the at least one movable printing platform is configured to individually move in a vertical direction relative to the printing table. The at least one processor may be further configured to control a first vertical movement of at least one of the printing table and the frame and control a second vertical movement of the at least one movable printing platform. The printing table may have a round shape and may include a plurality of printing platforms located at a common radial distance from a center of the printing table. The apparatus may further include at least one grinder for removing deposited material added to the at least one three-dimensional object between deposition steps in the additive manufacturing process.

In some embodiments, the at least one printing platform includes a heating element for heating from below the at least one three-dimensional object during the additive manufacturing process. The at least one processor may be configured to print the at least one three-dimensional object while maintaining the at least one three-dimensional product at a temperature different from at least another of the three-dimensional products.

In some embodiments, the apparatus includes at least two reservoirs for containing a differing additive manufacturing material in each reservoir, and wherein the at least one processor is configured to print the at least one three-dimensional object using a plurality of the differing additive manufacturing materials. In some embodiments, the apparatus may include at least one reservoir for containing a differing additive manufacturing material in each reservoir, and wherein the at least one processor is configured to concurrently print a plurality of three-dimensional objects at a common build rate using the differing additive manufacturing materials.

In some embodiments, the apparatus may include a plurality of reservoirs for containing a differing additive manufacturing material in each reservoir, and wherein the at least one processor is configured to concurrently print a plurality of three-dimensional objects at differing resolutions using the plurality of the differing additive manufacturing materials. In some embodiments, the apparatus includes at least two reservoirs for containing a differing additive manufacturing material in each reservoir, and wherein the at least one processor is configured to concurrently print a plurality of three-dimensional objects using the differing additive manufacturing materials in a manner such each object is constructed of additive manufacturing materials from a different one of the at least two reservoirs. In some embodiments, the at least one reservoir communicates with more than one print head.

Embodiments of the present disclosure provide the at least one processor may be configured to cause the at least one print head to concurrently print a plurality of three-dimensional objects at different heights. In some embodiments, the apparatus includes a plurality of print heads, and the at least one processor is configured to concurrently print a plurality of three-dimensional objects such that when at least one of the plurality of print heads is actively printing objects, another of the plurality of print heads are inactive.

In some embodiments, the at least one processor is configured to concurrently print three-dimensional objects on different printing platforms such that printing of at least one object is completed before the printing of at least one other object.

In some embodiments, the apparatus includes at least one heating device configured to control the temperature of multiple objects printed on different platforms in order to solidify the objects.

Embodiments of the present disclosure provide the at least one print head includes a plurality of print heads arranged in at least one of a rotational axis or an angular axis and a radial axis. The at least one print head may include a plurality of print heads and each print head comprises linear array of nozzles substantially arranged in the radial direction. Each print head may be shielded from heat and fumes by a cooled mask, wherein jetting is performed through slits in the mask. In some embodiments, the at least one print head includes a plurality of print heads associated with a plurality of printing units and wherein the plurality of printing units are arranged with a differing radial distance and print heads in each printing unit are arranged parallel to each other.

In some embodiments, the apparatus may further include a maintenance station positioned on a height-controlled platform on the printing table and maintained at constant height relative to the at least one print head. The maintenance station may include a wiper configured to wipe a mask bottom from accumulated condensed fumes, and inspection substrate to periodically test the jetting performance. The wiper may be disposed at a constant level below the at least one print head. The wiper may be located at one of: on the maintenance station, outside the rotating table, or included in a printing unit.

In some embodiments, the apparatus may include a uniform heater that uniformly heats the printing table. The uniform heater may be maintained at a constant distance below the printing table and not rotating with the printing table. The uniform heater is configured to heat the table by electromagnetic radiation.

According to embodiments of the present disclosure, a printing method is provided. The printing method may include supplying an additive manufacturing material in a fluid from at least one reservoir to at least one print head, wherein the at least one print head is configured to deposit the additive manufacturing material, using a printing table including at least one printing region for supporting at least one removable substrate for printing at least one three-dimensional object, wherein the at least one removable substrate is made from a material other than the additive manufacturing material, controlling a rotational movement between the at least one printing head and a printing table, and controlling a vertical movement of the at least one print head relative to the printing table.

In some embodiments, the printing table includes at least one independently movable printing platform on the printing table for supporting the at least one three-dimensional object. The at least one printing platform may include a plurality of printing platforms individually moveable in a vertical direction relative to the printing table. The method may further include controlling a vertical movement of each of the plurality of printing platforms relative to the printing table and controlling an additional vertical movement of at least one of the printing table and the frame.

In some embodiments, the method includes heating from below the at least one three-dimensional object during the additive manufacturing process. The method may include maintaining the at least one the three-dimensional product at a temperature different from at least another three-dimensional product.

In some embodiments, the method may include causing the at least of print head to concurrently print a plurality of three-dimensional objects at different heights. The method may include concurrently printing a plurality of three-dimensional objects such that printing of a layer of an object in a first printing platform is completed before the printing of a layer of another object in a second printing platform.

In some embodiments, an additive manufacturing apparatus having a round printing configuration is provided. The apparatus may include at least one frame for supporting at least one print head configured to deposit fluidic additive manufacturing material layer by layer. The additive manufacturing material may include a construction material and a carrier liquid. The apparatus may include at least one heating element for evaporating at least part of the carrier liquid. The apparatus may include a printing table including at least one printing region for supporting at least one removable substrate for printing at least one three-dimensional object, and at least one processor configured to: control a rotational movement between the at least one print head and the printing table; and control vertical movement between the at least one print head and the at least one removable substrate.

In some embodiments, the apparatus may include at least one reservoir in communication with the at least one print head, the at least one reservoir being configured to contain the additive manufacturing material. The construction material may include solid particles dispersed in the carrier liquid. The solid particles may include at least one of metal and ceramics. The apparatus may include a fume suction device for removing the evaporated carrier liquid from the printing area.

In some embodiments, the apparatus may include at least one movable printing platform on the printing table for supporting the at least one three-dimensional object, wherein the at least one movable printing platform is configured to individually move in a vertical direction relative to the printing table. The removable substrate may be disposed on the platform. In some embodiments, the removable substrate may be attached to its location by a vacuum force. The substrate may include a material of high heat conductance quality. The at least one processor may be further configured to control a first vertical movement of at least one of the printing table and the frame and control a second vertical movement and the at least one movable printing platform. The printing table may have a round shape and includes a plurality of printing platforms located at a common radial distance from a center of the printing table.

In some embodiments, the additive manufacturing apparatus may further include at least one grinder for removing leveling deposited material added to the at least one three-dimensional object between deposition steps in the additive manufacturing process. The grinder may be located at a constant height relative to the printing heads while leveling the deposited material, and the grinder is not rotating above the rotation axis of the printing table.

In some embodiments, the at least one printing platform includes a heating element for heating from below the at least one three-dimensional object during the additive manufacturing process. The heating element from below may heat the objects through the substrate. In some embodiments, the apparatus may include a heating element that heats the upper layer from above (e.g. an E.M. radiation source and/or heated air blow) In some embodiments, the radiation comprises UV and/or visible/and/or I.R. and/or micro-wave frequencies.

In some embodiments, the at least one processor may be configured to print the at least one three-dimensional object while maintaining the at least one three-dimensional product object at a temperature different from at least another of the three-dimensional object.

In some embodiments, the apparatus may include at least two reservoirs for containing a differing additive manufacturing material in each reservoir, and the at least one processor is configured to print the at least one three-dimensional object using a plurality of the differing additive manufacturing materials.

In some embodiments, the at least one processor is configured to concurrently print a plurality of three-dimensional objects at a common building height rate using. The at least one processor is configured to concurrently control a different movement from layer to layer of the at least one printing platform, such that the three-dimensional objects disposed on different substrates are built at different building height rates. The objects printed at different height rates may comprise different manufacturing materials The at least one processor may be configured to concurrently print a plurality of three-dimensional objects at differing resolutions using the plurality of the differing additive manufacturing materials. The at least one processor may be configured to concurrently print a plurality of three-dimensional objects such that each object is constructed of additive manufacturing materials from a different one of the at least two reservoirs.

In some embodiments, the heating source from above is turned off when a completed object of a small height passes under the heat source. After the printing of an object of small height completes, the object may be removed from the printing table. After the printing of all the objects on a first substrate completes, the substrate with the objects may be removed from the printing table.

The additive manufacturing apparatus according to any of the preceding claims, the at least one processor is configured to concurrently print three-dimensional objects on above different printing platforms such that printing of at least one second objects above a second platform is completed before the printing of at least one other a first objects above a first platform.

In some embodiments, the at least one processor is configured to start building a third objects above a third platform during the building process of the first object above the first platform. Before starting building above the third platform, the platform may move up, so that the first printed layer above the third platform is at the same height as the upper layer of the first objects concurrently printed above the first platform. In some embodiments, the third platform is the second platform, and before starting printing the third objects, the second objects is removed from above the second platform.

In some embodiments, the apparatus further includes at least one heating device per platform configured to control the temperature of multiple objects printed on different platforms in order to solidify the objects.

In some embodiments, the at least one print head includes a plurality of print heads associated with a plurality of printing units and wherein the plurality of printing units are arranged with a differing angular extent above the rotation axis of the printing table. In some embodiments, each unit includes at least one of printing heads, a shielding mask, a heating unit. The printing heads in a printing unit may be arranged parallel to each other. In some embodiments, all the building heads included in a printing unit communicate with the same reservoir. “Building heads” may refer to heads not supplying support material. In some embodiments, a unit also includes at least one head for printing supporting material, wherein the head communicates with a support material reservoir.

In some embodiments, the apparatus further includes a scrubbing unit for cleaning the heads' orifice plate from debris. The scrubbing unit may be located at one of: on the maintenance station, outside the rotating table, or included in a printing unit.

In some embodiments, the apparatus includes a heat shield outside the printing table configured to be maintained at a constant height from the at least one print head, wherein the heat shield includes at least one of: thermal insulator, thermal radiation reflector. In some embodiments, the apparatus includes a heater that uniformly heats the printing table.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

The accompanying drawings, which are incorporated in and constitute part of this disclosure, together with the description, illustrate and explain the principles of various exemplary embodiments.

FIG. 1 is a diagrammatic illustration of an exemplary additive manufacturing apparatus according to one embodiment of the disclosure;

FIG. 2 is a diagrammatic top-view illustration of a rotating tray included in the exemplary additive manufacturing apparatus;

FIG. 3 is a diagrammatic illustration of an exemplary additive manufacturing apparatus according to another embodiment of the disclosure;

FIG. 4 is a diagrammatic cross-section view illustration of a printing apparatus included in the exemplary additive manufacturing apparatus depicted in FIG. 1;

FIG. 5 is a diagrammatic illustration of an exemplary additive manufacturing apparatus according to an embodiment of the disclosure;

FIG. 6A shows a diagrammatic top view of a printing tray and removeable substrates;

FIG. 6B shows a diagrammatic bottom view of a plurality of print heads of FIG. 5;

FIG. 7 is a diagrammatic illustration of two printing heads in a single printing module illustrated in FIG. 4; and

FIG. 8 shows a printing method according to embodiments of this disclosure.

### DETAILED DESCRIPTION

Reference will now be made in detail to the example embodiments implemented according to the present disclosure, the examples of which are illustrated in the accompanying drawings. Wherever convenient, the same reference numbers will be used throughout the drawings to refer to the same or like parts.

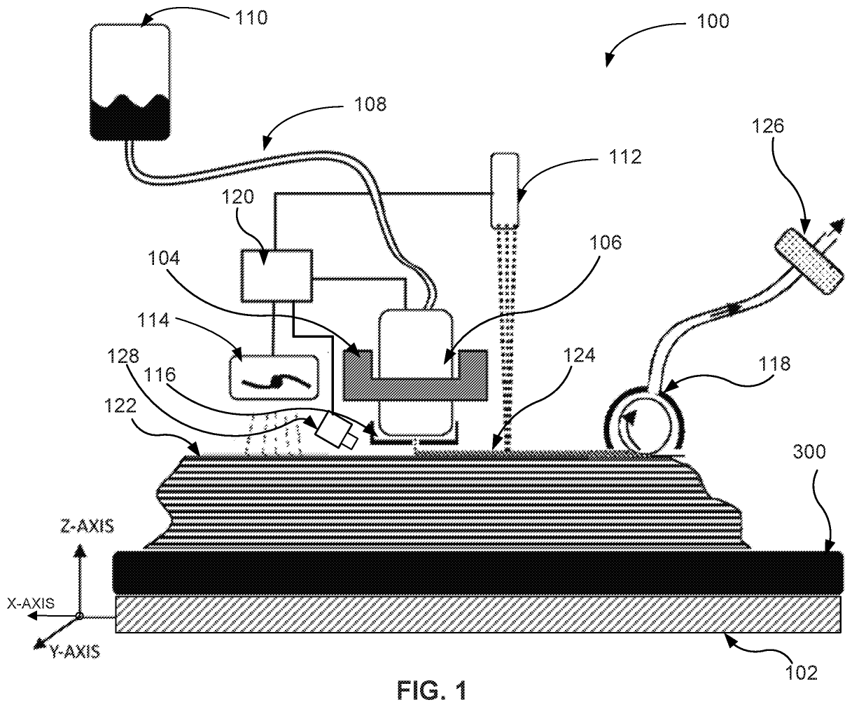

Disclosed embodiments include an additive manufacturing apparatus. As used herein, the term “additive manufacturing apparatus” broadly includes any device or system that can produce an object from a digital model by laying down successive layers of material until the object is created. FIG. 1 depicts an example of an additive manufacturing apparatus 100 in which various implementations, as described herein, may be practiced. As shown in FIG. 1, additive manufacturing apparatus 100 may include: a printing region 102, a print head frame 104 supporting at least one print head 106, at least one conduit 108 interconnecting print head 106 with an additive manufacturing material reservoir 110, a heat source 112, a cooling fan 114, a heat shield 116, a leveling apparatus 118, and a controller 120. The leveling apparatus 118 may be a roller, one or more blades, a drill, or any other structure that can ensure each layer of the object is level.

In accordance with the present disclosure, an additive manufacturing apparatus having a round printing configuration is disclosed. In one embodiment, the additive manufacturing apparatus may include a modular structure that incorporates components that allow for additive manufacturing, as will be described in more detail below. The additive manufacturing apparatus may include at least one frame (e.g., print head frame 104) for supporting at least one print head configured to deposit fluidic additive manufacturing material layer by layer. The frame may support one or more print heads. The frame may be configured to hold the one or more print heads at a fixed distance from a printing surface or at a changing distance from the printing surface. In some examples, the term “frame” may be used interchangeably with the term “printing assembly”. The term “print head” may refer to a plurality of nozzles organized in a linear array or plate. In some embodiments, the plurality of nozzles may be generally manufactured together as one assembly or unit. The at least one print head may be configured to deposit the fluidic additive manufacturing material layer by layer. The phrase “layer by layer” refers to the additive manufacturing process that includes laying down successive layers of material, causing the height of the object to gradually grow.

The additive manufacturing apparatus may be configured to print more than one type of additive manufacturing material. The term “additive manufacturing material” includes any fluid intended for deposition on a printing surface in a desired pattern. The term “additive manufacturing material” is also known as “printing material”, “printing liquid”, and “ink”. These terms may be used interchangeably in this disclosure. Consistent with the present disclosure, some examples of suitable inks may include one or more of the following ingredients:
Micro and/or nano particles—The inks described herein may include a dispersion of solid particles of any required material, e.g., metals (iron, copper, silver, gold, titanium, aluminum, etc.), metal oxides, oxides (SiO2, TiO2, BiO2 etc.), metal carbides or other carbides (WC, Al4C3, TiC, etc.), metal alloys (stainless steel, Titanium Ti64, etc.), hydrides (TiH2) inorganic salts, polymeric particles, ceramic, etc., in carrier liquid, as described in further detail below. The particles may be of micro (0.5 to 10 micrometer size) and/or nano (5 to 500 nanometer size) as required to maintain the required spatial resolution during printing, maintain the required material character (after sintering), and/or to satisfy limitations of a dispensing head. For example, when the dispensing print head includes nozzles of 30 μm diameter, the particles size may be equal to or smaller than 2 μm. In the context of this document, the term “object material” generally refers to solid particles used to construct the object. “Support material” generally refers to materials used to construct support elements. The support elements are not part of the desired object and may be removed after printing before or during the sintering process. Removal of the support material removal may be done by evaporating, burning or dissolving in a liquid prior or after de-binding, or after sintering, among other ways. De-binding is the process of removing the binder and any other foreign material (often organic molecules) from the green object prior to sintering. De-binding is often done by chemical dissolution of the foreign material, or by heating the green object to few hundred degrees (Celsius, a temperature smaller than the sintering temperature). The term “green object” is the product of the printer before de-binding and sintering. Exemplary support material may include wax, which can be removed by dissolving in an organic solvent or evaporating and or burning at high temperature, and salts such as sodium carbonate and sodium chloride that can be dissolved in water or acid water.
Carrier liquid—The particles may be dispersed in a carrier liquid, also referred to as a “carrier”, “solvent”, or “volatile part”. According to one embodiment, the carrier liquid may evaporate immediately after printing so that the succeeding layer is dispensed on solid material below. The temperature of the upper layer (the layer on which a succeeding layer is dispensed) may be lower than the boiling temperature of the carrier liquid. The ink is dispensed onto the solid layer and then heated to evaporate the carrier liquid wherein the carrier liquid may be evaporated at a temperature which is lower, equal or higher than the carrier liquid boiling temperature. The carrier liquid evaporates during the formation of each layer in the printing machine. After completing printing (and obtaining the Green object) a further heating step is required to fire off the dispersing agent (see later) and other additional foreign components in the ink, e.g. binder. Often the dispersing agent performs also as a binder, after evaporating the carrier liquid. Furthermore, when the upper layer is heated to a temperature higher than the boiling temperature of the carrier liquid, the layer is cooled to a temperature lower than the liquid carrier boiling temperature (by about 40-80 degrees C.) before dispensing a succeeding layer of ink onto the solidified layer.
Dissolved material—At least part of a solid material to be used to construct the object can be dissolved in the carrier liquid. The dissolved material may also be referred to as “the non-volatile part.” For example, a dispersion of silver (Ag) particles may be the non-volatile part, which, in addition to the Ag particles includes a fraction of Ag organic compound dissolved in the carrier liquid. After printing and during firing, the organic portion of the Ag organic compound fires off.
Dispersing agent—In order to sustain particle dispersion, a dispersing agent, also known as dispersant, may assist in dispersing the particles in the carrier liquid. Dispersants are known in the industry and are often a kind of polymeric molecule. In general, the dispersing molecules adhere to the solid particle's surface (i.e., wrap the particles) and inhibit agglomeration of the particles to each other. When more than one solid particle species is dispersed in the dispersion, using the same dispersant material for all solid particle species may be selected to reduce or prevent the likelihood of compatibility problems between different dispersant materials. The dispersing agent may also be selected to dissolve in the carrier liquid so that a stable dispersion can be formed. Conventional dispersants are readily available, such as polymeric dispersants.

FIG. 1 illustrates an additive manufacturing apparatus 100 that may include print head frame 104 for maintaining at least one print head 106 spaced from printing surface 122. The term “print head frame” or simply “frame” may include any structure suitable for holding or retaining at least one print head 106 in a fixed distance from printing surface 122 or at a changing distance from printing region 102. Because the additive manufacturing process includes laying down successive layers of material, the height of the object is gradually growing. In one embodiment, after each layer is laid down, printing region 102 shifts lower in the Z-direction to maintain the fixed distance between at least one print head 106 and printing surface 122. In an alternative embodiment, after each layer is laid down, print head frame 104 shifts higher in the Z-direction to maintain the fixed distance between at least one print head 106 and printing surface 122. In one example, the fixed distance between print head 106 and printing surface 122 may be any value between 0.5 and 5 mm. In another embodiment, after each layer is laid down, printing region 102 shifts lower in the Z-direction and print head frame 104 shifts higher in the Z-direction to maintain the fixed distance between at least one print head 106 and printing surface 122.

According to embodiments of the present disclosure, the additive manufacturing apparatus may include at least one reservoir in communication with the at least one print head, the at least one reservoir being configured to contain the additive manufacturing material. The term “reservoir” may refer to any structure capable of storing and containing the additive manufacturing material. The reservoir may be in communication with the at least one print head via a conduit. The term “conduit” may refer to a body having a passageway through it for the transport of a liquid or a gas.

In some embodiments, additive manufacturing apparatus 100 may include at least one conduit 108 interconnecting print head 106 with an additive manufacturing material reservoir 110. At least one conduit 108 may be flexible to enable relative movement between print head 106 and additive manufacturing material reservoir 110. In some embodiments, at least one conduit 108 may include a supply conduit interconnecting additive manufacturing material reservoir 110 with print head 106 for supplying material to print head 106, and a return conduit (not shown) interconnecting print head 106 with additive manufacturing material reservoir 110 for circulating back to additive manufacturing material reservoir 110 at least a portion of the material that was not expelled from print head 106.

The additive manufacturing material reservoir may include any structure configured to store ink until it is conveyed to print head 106. In some embodiments, additive manufacturing material reservoir 110 may include one or more tanks and/or an ultrasound-based element that is configured to send ultrasound or shock waves into the ink to prevent solid particles agglomeration in the ink or to break agglomerates if they already exist in the material. In addition, additive manufacturing apparatus 100 may include a plurality of valves (not shown) operated by controller 120 and positioned along on at least one conduit 108 to control the pressure in at least one print head 106, at least one conduit 108, and/or additive manufacturing material reservoir 110.

According to the present disclosure, the additive manufacturing apparatus may include a printing table including at least one printing region for supporting at least one removable substrate for printing at least one three-dimensional object. The term “printing table” may refer to a table, surface, or any other suitable type of support that supports the one or more removeable substrates. The printing table may include several printing regions. Each printing region may support a removable substrate on which the object are printed. The terms “printing tray” and “printing table” may also be used interchangeably in this disclosure. The term “printing region” includes an area with any surface, such as a rigid surface that may be attached or removably attached to the printing table, capable of holding multiple layers of material dispensed from additive manufacturing apparatus 100. The term “printing region” may in some embodiments be different than the term “printing surface.” The term “printing surface” refers to a surface on which a new layer is to be printed. The term “removeable substrate” refers to the base material on which each object is printed. On each substrate one or more objects can be simultaneously printed. The removable substrate may be attached to the printing table using vacuum, gripper (with or without a spring), sliding rails, sliding slot, or any suitable mechanism for removably attaching the substrate to the printing table. In some embodiments, the substrate may be attached to the printing table such that the substrate is not removeable. The at least one removable substrate may be made from a material other than the additive manufacturing material. In a non-limiting example, the removable substrate may be made from aluminum covered with nickel. In another embodiment, the removeable substrate may be made of the same material as the additive manufacturing material.

FIG. 1 illustrates that printing region 102 may be used as a base for supporting a removeable substrate 300 that may be used for supporting the object to be constructed in an additive manufacturing process. In one embodiment, printing region 102 may include thermally conductive material, for example, printing region 102 may include a tray made of metal. In this embodiment, printing region 102 may be warmed to a required object temperature to assist in solidifying a recently printed layer or to accelerate the evaporation of at least part of the additive manufacturing material liquid components. In alternative embodiment, printing region 102 may include thermally insulating material, e.g., printing region 102 may include wood, plastic, or insulating ceramics. In both embodiments, the printing region 102 may keep the object's temperature and heating the recently printed layer may be accomplished by direct heat radiation from above, for example, using heat source 112 such as a halogen lamp, I.R. lamp, UV lamp, a laser, flash-lamp, or microwave source, as will be discussed in further detail below.

In the beginning of the printing process, for example, printing region 102 may be the printing surface because the first layer may be printed directly on it. All the subsequent layers (e.g., the second layer), however, may be printed on top of previously deposited layer. Thus, in this example, the first layer is the printing surface for the second layer. With reference to FIG. 1, a printing surface 122 may therefore be a previously deposited layer, and a new layer 124 may be the layer that is currently being printed on top of printing surface 122. New layer 124 may be built along the Z-direction during every printing pass and is also referred to as the upper-layer or the most-recent layer.

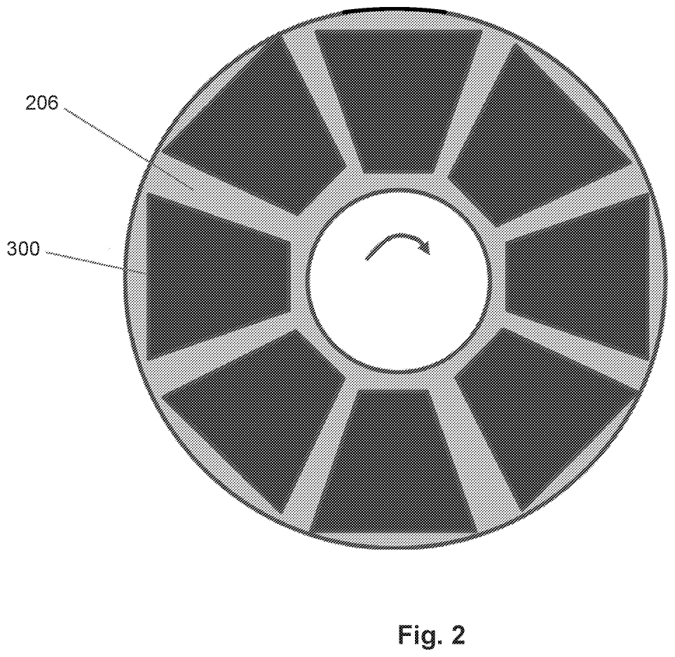

FIG. 2 illustrates a diagrammatic top-view illustration of a rotating tray 206. As shown, rotating tray 206 may include several removable substrates 300 on rotating tray 206. On each substrate, one or more objects can be simultaneously printed. In one embodiment, additive manufacturing apparatus 100 may include a rotating service area (not shown) that includes head service elements kept at constant Z space from the printing module. The service area and service elements may be embedded in rotating tray 206, for example, in-between removable substrates 300. Alternatively, the rotating service area with service elements may be situated outside or inside rotating tray 206. In this case, the print heads may be moved radially to above the rotating service area for servicing. In another embodiment, a plurality of service areas may be located respectively to the plurality of printing modules outside or inside rotating tray 206. In another embodiment, one or more service elements, e.g. mask wiper, may be located on rotating tray 206, while one or more others, e.g., heads, wipers, may be located outside rotating tray 206.

The additive manufacturing apparatus 100 illustrated in FIG. 1 can produce any object from a digital model. To do so, additive manufacturing apparatus 100 may include a processing device, such as controller 120, for controlling the operation of different printing components. According to some embodiments, controller 120 may include at least one processor configured to determine operations of additive manufacturing apparatus 100. In some embodiments, controller 120 may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically, wirelessly, or by any other means that permit them to interact.

Controller 120 may also include one or more memory devices. The at least one processor may constitute any physical device having an electronic circuit that performs logic operations on input or inputs. For example, the at least one processor may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into a controller or may be stored in a separate memory. The memory may include a Random-Access Memory (RAM), a Read-Only Memory (ROM), a hard disk, an optical disk, a magnetic medium, a flash memory, other permanent, fixed, or volatile memory, or any other mechanism capable of storing instructions.

According to the present disclosure, the additive manufacturing apparatus may further include at least one processor configured to control a rotational movement between the at least one print head and the printing table. For example, the at least one processor may control the at least one print head to rotate with respect to the printing table. In that case, a material reservoir is comprised in the rotating subsystem with the head In another example, the at least one processor may control the printing table to rotate with respect to the at least one print head. Additionally, the at least one processor may be configured to control a rotational movement between the at least one print head and the substrate.

In one embodiment, the processor may also be configured to control vertical movement between the at least one print head and the printing table. For example, the at least one processor may instruct the at least one print head to move vertically (i.e. in the Z direction) with respect to the printing table. In another example, the at least one processor may instruct the printing table to move vertically with respect to the at least one print head. In another example, the at least one processor may instruct both the printing table and the at least one print head to move vertically.

The printing table 204 may be stationary or moveable. According to one embodiment, printing table 204 may include a rotating surface which may be round. Additionally, printing table 204 may be configured to move vertically (Z axis) down and/or up.

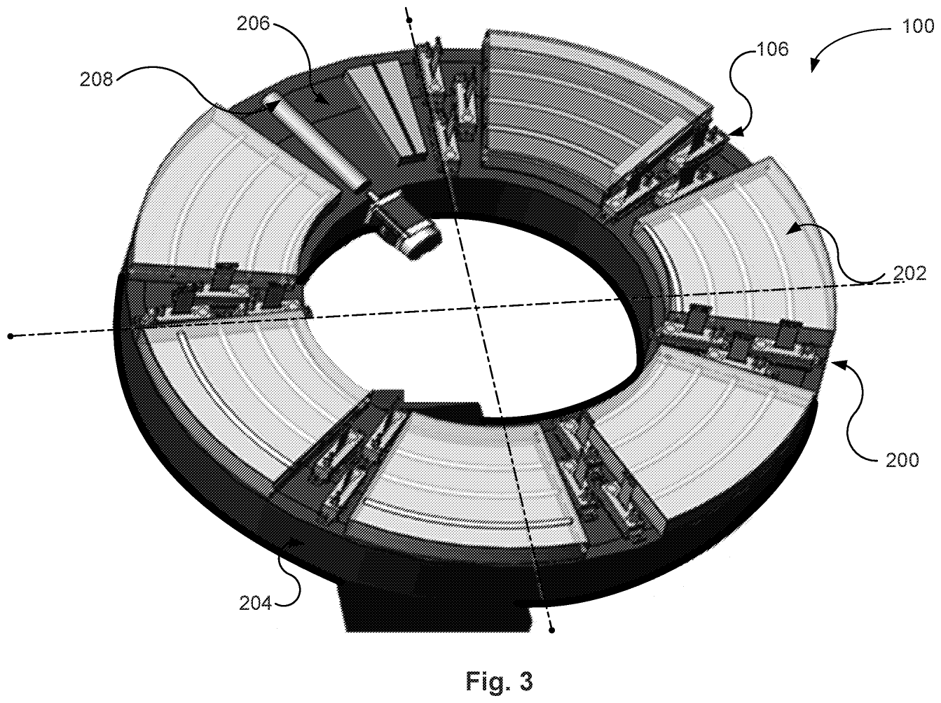

In some embodiments, additive manufacturing apparatus 100 may include two rotating options. As illustrated in FIG. 3, in the first rotation option, printing table 204 may rotate while the at least one printing module 200 is stationary. In this rotation option, the at least one printing module 200 may radially move from cycle to cycle to improve the uniformity of the printed surface and to decrease impact of weak nozzles. The radial movement is also used for moving the module to a maintenance area. Additionally, in this rotation option, printing module 200 and/or printing table 204 may move in the Z axis direction. The Z movement may be either continuous along the rotation time, or in steps, e.g. stepping down once every rotation cycle. In the second rotation option, printing table 204 may be stationary and at the least one printing module 200 rotates. In case there are a plurality of printing modules 200, they may rotate together. In more general terms, the entire printing assembly, optionally including the material reservoir(s), rotates. In this rotation option, printing module 200 and/or printing table 204 may move in the Z axis direction. In both rotation options, rotating tray 206 may gradually move down, the printing modules 200 may move up, and any combination of the above. In some embodiments, the platforms that are located on the table (when located), may gradually move down.

Consistent with the present disclosure, additive manufacturing apparatus 100 may have a mechanical configuration that fits the rotation option. For example, additive manufacturing apparatus 100 may have mechanical configuration that supports rotation of tray 206, or a mechanical configuration that supports rotation of the at least one printing module 200 and the heating elements. For example, additive manufacturing apparatus 100 may include a rotational connector to convey electricity to rotating tray 206 in order to warm it. In any event, in one embodiment, controller 120 may compensate rotational side-effects to the printing, by adjusting the rotational configuration of additive manufacturing apparatus 100.

According to some embodiments, the additive manufacturing apparatus may include at least one movable printing platform on the printing table for supporting the at least one three-dimensional object, wherein the at least one movable printing platform is configured to individually move in a vertical direction relative to the printing table. The term “printing platform” may also be referred to as a stage, a support, or a stand, that may be individually controllable in the vertical direction. The at least one printing platform may support the at least one three-dimensional object to be printed on the at least one printing platform. In one embodiment, the at least one printing platform may include a plurality of printing platform (e.g., more than three, more than five, less than ten), each of which may be individually controllable in the vertical direction. The at least one printing platform may be connected to the printing table and may be positioned between the printing table and the removeable substrate. As such, the at least one printing platform may support the removeable substrate and the three-dimensional object. The at least one moveable platform may be moveable in a vertical direction (i.e. Z-axis) relative to the printing table and the at least one print head. The at least one printing platform may include a mechanical construction capable of moving in a vertical direction in relation to the printing table.

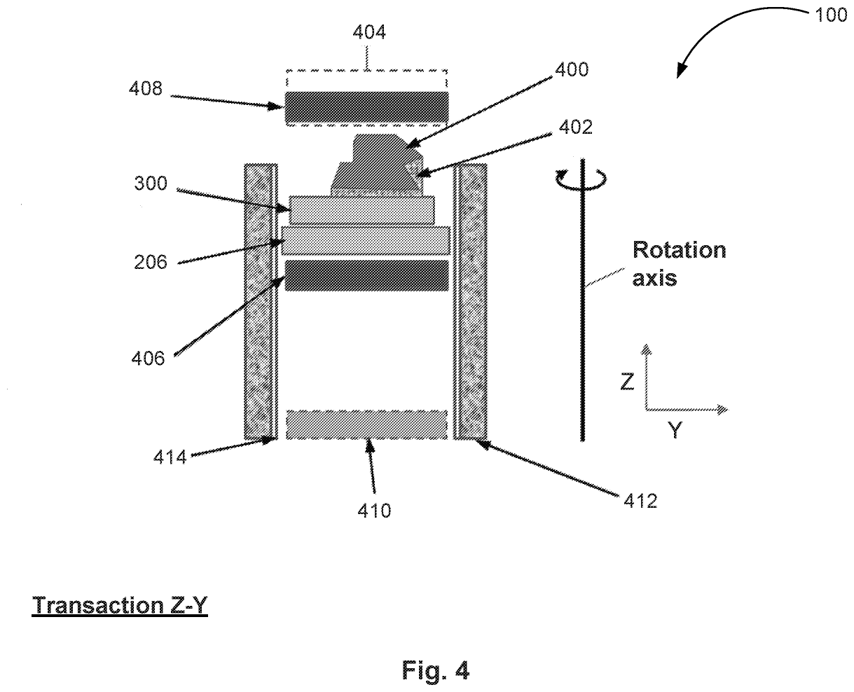

FIG. 4 illustrates additive manufacturing apparatus 100 printing an inorganic object 400 and support 402 from inkjet head(s) 404. Consistent with the present disclosure, additive manufacturing apparatus 100 may be configured to keep removable substrate 300 at high temperature (e.g., between 140° C. to 275° C., between 200° C. to 300° C., or between 200° C. to 450° C.). As discussed above, the heating of removable substrates 300 may take place in one or more ways. In one example, additive manufacturing apparatus 100 may include heating elements 406 that are attached to rotating tray 206 that holds substrates 300. For example, heating elements 406 may include electromagnetic (EM) radiating lamps, ultraviolet (UV) heat source, hot air blowers, infrared (IR) radiation lamps, and/or diodes, among other heating elements. In another example, additive manufacturing apparatus 100 may include a non-rotating heating assembly 406 (e.g., EM radiating lamps) that may be closely separated from rotating tray 206. Heating assembly 406 may move in the Z axis direction to keep a constant distance from rotating tray 206. In one example, additive manufacturing apparatus 100 may use heating assembly 408 to warm substrate 300 before and/or during printing. In addition, substrates 300 may have low thermal capacity and low thermal conductivity. In another example, additive manufacturing apparatus 100 may include a non-rotating heating assembly 410 that is stationary in the Z axis direction, and the space from rotating tray 206 varies along the printing session.

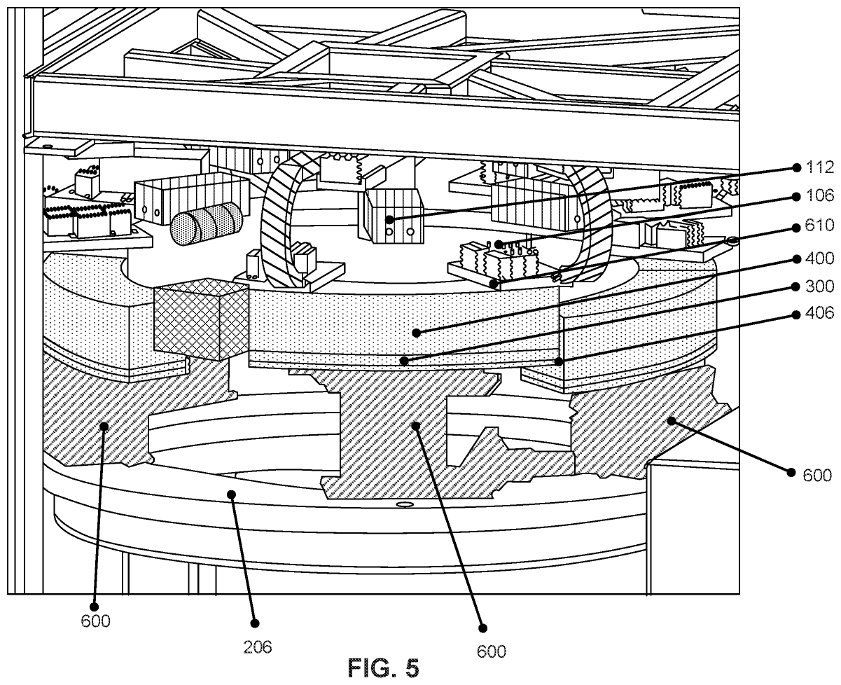

FIG. 5 illustrates the additive manufacturing apparatus 100 may include at least one movable printing platform 600 on the printing table 204 for supporting the at least one three-dimensional object 400. The printing platform 600 may have any appropriate shape such that the printing platform 600 may be positioned on the printing table 204 and may extend in a vertical direction away from the printing table 204. The at least one movable printing platform 600 is configured to individually move in a vertical direction relative to the printing table 204 and print head 106. For example, three printing platforms 600 are shown in FIG. 5, each of the printing platforms 600 may be configured to move independently of the other printing platforms 600. It is also to be understood that any number of printing platforms 600 may be utilized.

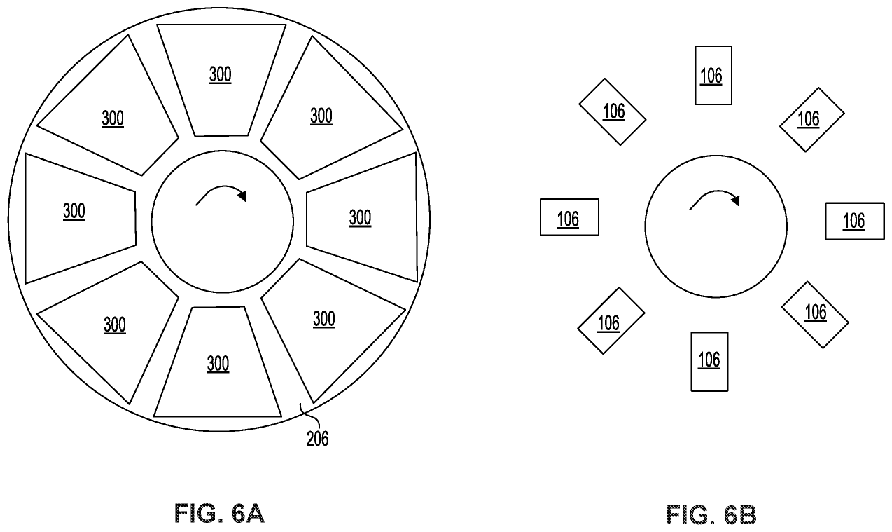

FIGS. 6A and 6B illustrate an exemplary embodiment of the present disclosure providing a plurality of removeable substrates 300 arranged in a round pattern around the rotating tray 206 and the opposing plurality of print heads 106 arranged in an exemplary pattern to match the pattern of removeable substrates 300. According to some embodiments, print head frame 104 may support a single print head 106 or a plurality of print heads 106 as shown in FIG. 6B. When print head 106 is connected to additive manufacturing apparatus 100, a plurality of nozzles may be configured to dispense material from additive manufacturing material reservoir 110 to form the object layer-by-layer. In one example, at least one print head 106 may include a plurality of nozzles including a first nozzle group for dispensing a first material and a second nozzle group for dispensing a second material that differs from the first material. In one embodiment, the first material may be a first type of object material, and the second material may be a second type of object material when, for example, the desired object consists of two different materials. In another embodiment, the first material may be an object material used to produce the desired object, and the second material may be a support material used temporarily during printing, for example, to support “negative” tilted walls of the object. Print head 106 may scan a new layer in an X-direction substantially perpendicular to the longitudinal axis Y of the new layer. As each object may be constructed from thousands of printed layers, thousands of cycles may be necessary. In a case where each cycle includes multiple printings from a plurality of print heads 106, the number of cycles can be reduced from thousands to hundreds or less. Also, additive manufacturing apparatus 100 may produce multiple objects in the same run. In one embodiment, different print heads 106 may be employed for different printing materials. For example, a first print head may be used for dispensing object material and a second print head may be used for dispensing support material.

In some exemplary embodiments, the at least one processor is further configured to control a first vertical movement of at least one of the printing table and the frame and control a second vertical movement of the at least one movable printing platform. Accordingly, the at least one processor may control the vertical movement between the printing table and the frame holding the at least one print head. The processor may also control the vertical movement of the at least one moveable printing platform. For example, the at least one processor may instruct the at least one print head to move vertically (i.e. in the Z direction) with respect to the printing table, and the processor may instruct the at least one moveable printing platform to move vertically. In some embodiments, the vertical movement of the at least one moveable printing platform may be accomplished manually, where a user may physically move the at least one moveable platform to a desired height.

In some embodiments, printing module 200 and/or printing table 204 may move in the Z axis direction. The Z movement may be either continuous along the rotation time, or in steps, e.g. stepping down once every rotation cycle. In the second rotation option, printing table 204 may be stationary and at the least one printing module 200 moves vertically. In case there are a plurality of printing modules 200, they may move vertically together or individually. In this rotation option, printing module 200 and/or printing table 204 may move in the Z axis direction. In both vertical movement options, rotating tray 206 may gradually move down, the printing modules 200 may move up, and any combination of the above. Additionally, the printing platform 600 may vertically move independently from and with respect to the rotating tray 206 and the printing module 200.

Consistent with the present disclosure, additive manufacturing apparatus 100 may have a mechanical configuration that fits the vertical movement option. For example, additive manufacturing apparatus 100 may have mechanical configuration that supports vertical movement of tray 206, a mechanical configuration that supports vertical movement of the at least one printing module 200 and the heating elements, and a mechanical configuration that supports vertical movement of the at least one printing platform 600.

According to some embodiments, the printing table (notated also as tray) has a round shape and includes a plurality of printing substrates located at a common radial distance from a center of the printing table. The term “round table” does not exclude tables that are not round, but rather means that the printable area on which 3D objects can be printed is round. The table shape may be of ring shape, having short and long radii that specify the area on which objects can be printed. A round printing configuration may be used to increase production throughput. The round printing configuration may be used with a continuous rotation between the print heads system and a printing tray, along with gradual increase of Z (vertical motion) separation between the print heads system and the substrates, so that the printed layer is at constant Z distance from the print heads. The plurality of printing platforms may located on the table, arranged around the table's center at a common radial distance from the center of the printing table. The term “common radial distance” may refer to the distance from each printing platform to a center point of the printing table or tray. Each printing platform positioned at the common radial distance from the center of the printing table may create a circular pattern of printing platforms around the round printing tray. In some embodiments, the printing table (notated also as tray) has a round shape and includes a plurality of printing platforms located at a common radial distance from a center of the printing table.

As shown, in FIGS. 3, 6, and 6A, rotating tray 206 may include several removable substrates 300 positioned on printing platforms 600 on rotating tray 206. On each substrate one or more objects can be simultaneously printed. In one embodiment, additive manufacturing apparatus 100 may include a rotating service area (not shown) that includes head service elements kept at constant Z space from the printing module. In this case, the print heads may be moved radially to above the rotating service area for servicing. In another embodiment, a plurality of service areas may be located respectively to the plurality of printing modules outside or inside rotating tray 206.

As shown in FIG. 3, additive manufacturing apparatus 100 may include at least one printing module 200 (also referred to as printing group) that includes at least one printing head. In one embodiment, the at least one printing module 200 may include a heating element. Alternatively, the heating element may be separated from the at least one printing module 200. In one example, printing module 200 may include, for example, two print heads, three print heads, or more. In one example, additive manufacturing apparatus 100 may include a first printing module 200 for printing a first type of printing material and a second printing module 200 for printing a second type of support material. Additive manufacturing apparatus 100 may simultaneously print layers of different materials on different objects or on the same object. As illustrated in FIG. 3, additive manufacturing apparatus 100 may include a plurality of printing modules (also referred to as printing units) 200, for example, six printing modules. In some embodiments, the heating element 202 may be integrated with or a part of the printing modules.

Consistent with disclosed embodiments, additive manufacturing apparatus 100 may include a rotating tray 206, a leveling roller 208, at least one additive manufacturing material reservoir (not shown), a plurality of image sensors 128 (FIG. 1) configured to acquire images of the printed model (not shown), and additive manufacturing material delivery system (not shown). The additive manufacturing material reservoir may contain 3D building material and/or support material. The support material may include material that can be removed by dissolution after solidification and completion of the printing, for example, water soluble materials. Consistent with disclosed embodiments, additive manufacturing apparatus 100 may include a solvent treating module (not shown) for collecting and treating the solvents from the support and/or printing materials evaporating from solidifying module 202. In some embodiments of the present disclosure, additive manufacturing apparatus 100 may include a calibration module (not shown) and a nozzle inspection module (not shown).

Due to a variety of reasons, including different jetting power of the different nozzles and liquid surface tension, the recently deposited layer may not be perfectly flat and the layer's edge may not be perfectly sharp. Therefore, embodiments of the present disclosure may further include at least one grinder for removing deposited material added to the at least one three-dimensional object between deposition steps in the additive manufacturing process. The term “grinder” can refer to any structure that can remove undesirable material that has been added to the at least one three-dimensional object. In some non-limiting examples, the grinder may be referred to as a leveler for leveling and smoothing of the upper surface during printing by removing part of the deposited material added to the at least one three-dimensional object between deposition steps or layers in the additive manufacturing process. In some embodiments, the grinder can be a roller comprising one or more blades, a drill, or any other structure that can remove undesirable material that has been added to the at least one three-dimensional object. The grinder may be used after each layer of material is output to the three-dimensional object in order to ensure each layer of the three-dimensional object has the desired amount and shape of material present. The grinder may be positioned at a constant height and angular extent with respect to the at least one print head and may be included in the printing assembly described herein.

For example, with reference to FIG. 1, additive manufacturing apparatus 100 may also include leveling apparatus 118 to flatten new layer 124 and/or sharpen one or more edges of new layer 124. In one embodiment, leveling apparatus 118 may include a vertical or horizontal grinding roller or cutting roller. In another embodiment, leveling apparatus 118 may include a dust filter 126 to suck the dust output of leveling. During the printing process, leveling apparatus 118 may operate on new layer 124 while the layer is being dispensed and solidified. In one example, leveling apparatus 118 may peel off between about 5% and 20% of material of the upper-layer's height. In some embodiments, leveling apparatus 118 meets the additive manufacturing material after the carrier liquid had evaporated and new layer 124 is at least partially dry and solid.

According to some embodiments, the at least one printing platform includes a heating element for heating the at least one three-dimensional object during the additive manufacturing process. The term “heating element” may refer to any device configured to supply heat to the three-dimensional object. The heating element may be a heat source, electromagnetic (EM) radiating lamps, hot air blowers, I.R. radiation lamps, and/or diodes. The heating element may be connected to the printing platform below the three-dimensional object to supply heat from below the thee-dimensional object.

For example, with reference to FIG. 1, the heating element may include an energy source, for example, heat source 112. The term “energy source” includes any device configured to supply energy to an object being printed by additive manufacturing apparatus 100. For example, supplying energy in form of radiation or heat to new layer 124 may be used to evaporate the dispersant material and other organic additives and optionally initiate at least partial sintering between the object particles. In one example, heat source 112 may include a small spot size energy source, such as a lamp or a laser configured to irradiate or scan a line along new layer 124 to cause in situ debinding or sintering or at least partial sintering to a newly formed layer 124. In another example, heat source 112 may include a flash-lamp configured to cover an area of newly formed layer 124 to initiate partial or full in situ sintering or debinding. According to this aspect of the disclosure, heat source 112 may be configured to selectively sinter model additive manufacturing material only in order to avoid support additive manufacturing material sintering. Such selectivity may be achieved by irradiating new layer 124 with wavelengths which are absorbed more in a model additive manufacturing material than in a support additive manufacturing material and/or by adding pigments to the model additive manufacturing material, which increases its energy absorption to the irradiated wavelengths. Inkjet printing of inorganic material may involve solidification by evaporation using heat. Accordingly, additive manufacturing apparatus 100 may warm the printed layer to a temperature higher than a minimum, e.g., 175° C.

In one embodiment, energy source may be incorporated with printing region 102 to form a warm tray. When the printed object is being heated from below the heat constantly flows up to new layer 124, and because of the heat-flow resistance of the material, a temperature gradient is built: high temperature at the bottom of the object and low at the upper surface of the object (along the Z-axis). The temperature of the warm tray may be controlled higher and higher dependently on the interim height of the object during printing, so as to keep the temperature of the upper-layer constant. In another embodiment that is illustrated in FIG. 1, heat source 112 may be located above the object being printed. The direct heating by the heat source 112 can encourage constant temperature of new layer 124. The heat source 112 may be positioned aside print head 106 and can produce thermal radiation. In a third embodiment, energy source may include an aperture configured to blow a stream of hot air on new layer 124. The use of hot air may increase the temperature of new layer 124 and assist in evaporation of liquid carrier from new layer 124. In addition, a combination of any of the first, second, and third embodiments may be used to maximize the heating and/or evaporation performances.

The warming of new layer 124 may be part of the additive manufacturing process. In some embodiments, however, the rest of the printed object should not be maintained at the same temperature as new layer 124. Accordingly, additive manufacturing apparatus 100 may include a cooling fan 114 for dissipating the heat stored in a recently printed layer to the surrounding air. One reason to cool a recently printed layer may be that when additive manufacturing material droplets land on a surface with a temperature high above the boiling temperature of a carrier liquid (e.g., by 30° C.) they may explode rather than attach to the surface, such as when water droplets land on a surface of 120° C. Thus, the rest of the object is not required to be maintained the same temperature as the temperature of new layer 124, only to be maintained at a constant and uniform temperature. For example, new layer 124 may be warmed to a temperature higher than the boiling temperature of the carrier liquid (e.g., new layer 124 can be warmed to about 400° C.) when the previously printed layers may be maintained at a relatively lower temperature (e.g., about 230° C.) using cooling fan 114.

Embodiments of the present disclosure provide the at least one processor may be configured to print the at least one three-dimensional object while maintaining the at least one three-dimensional product at a temperature different from at least another of the three-dimensional products. In some embodiments, the processor may store instructions that cause the at least one three-dimensional object to be maintained at a temperature higher than the temperature of another three-dimensional object. In other embodiments, the processor may store instructions that cause the at least one three-dimensional object to be maintained at a temperature lower than another of the three-dimensional products. The at least one processor may maintain three-dimensional objects at different temperatures due to differing materials, differing build rates, differing resolutions. In other embodiments, the at least one processor may maintain the three-dimensional objects at the same temperature, the same build rates. and the same resolutions.

In some embodiments, the heat source may be incorporated with printing region 102 to form a warm tray. The temperature of the warm tray may be controlled higher and higher dependently on the interim height of the object during printing, so as to keep the temperature of the upper-layer constant. Each tray 206 may be individually controllable such that the temperature of each tray 206 may be the same or may differ as needed. In one embodiment, the at least one processor may maintain three-dimensional objects at different temperatures using different heating elements. For example, a first object may be associated with a first printing element (e.g., a first warming tray) and a second object may be associated with a second printing element (e.g., a second warming tray).

Some embodiments of the present disclosure include at least two reservoirs for containing a differing additive manufacturing material in each reservoir. The at least one processor may be configured to print the at least one three-dimensional object using a plurality of the differing additive manufacturing materials. The additive manufacturing apparatus may include at least two reservoirs, the at least two reservoirs may have any structure capable of storing and containing the additive manufacturing material. The at least two reservoirs may contain the same additive manufacturing material or differing additive manufacturing materials. For example, one of the at least two reservoirs may include a support material as described above and another of the at least two reservoirs may include a carrier liquid. In another embodiment, the carrier liquid and the support material may be in the same reservoir and another additive manufacturing material may be in another of the at least two reservoirs. The at least two reservoirs may be in communication with the at least one print head via at least two conduits.

Consistent with the present disclosure, additive manufacturing apparatus 100 may have modular design. Specifically, additive manufacturing apparatus 100 may include several printing modules 200. Each printing module 200 includes at least one printing head, and optionally a heating element, that may be customized for the specific material dispensed by the head. With a modular design, additive manufacturing apparatus 100 may be assembled in different configurations using the same platform, and the capabilities of an existing printer may be upgraded or enhanced by adding new printing modules 200. For example, the addition or the replacement of printing modules 200 may increasing the printer's throughput, configure the printer for printing of multiple materials, etc. In addition, according to some embodiments, additive manufacturing apparatus 100 may be configured with a plurality of printing modules 200 to print multiple layers in an object in a single rotation. In other embodiments, additive manufacturing apparatus 100 may be configured with a plurality of printing modules 200 to print multiple materials from multiple reservoirs 110 in one rotation. For example, in a single rotation of rotating tray 206, a first printing module 200 may print a first layer using a first material from the reservoir 110, a second printing module 200 may print a first layer using a second material from a second reservoir, a third printing module 200 may print a first layer using a third material from a third reservoir, a fourth printing module 200 may print a second layer using the first material, a fifth printing module 200 may print a second layer using the second material, a sixth printing module 200 may print a second layer using the third material; and so on.

Some embodiments of the present disclosure provide at least one reservoir for containing a differing additive manufacturing material in each reservoir. The at least one processor is configured to concurrently print a plurality of three-dimensional objects at a common build rate using the differing additive manufacturing materials. The term “concurrently printing the plurality of three-dimensional objects” refers to two (or more) additive manufacturing processes that may occur during coincident or overlapping time periods, either where one begins and ends during the duration of the other or where a later one starts before the completion of the other. In one embodiment, the top layers of at least two objects located in separated printing platforms may be deposited at the same time. In another embodiment, the top layers of at least two objects located in separated printing platforms may be deposited at separate times. It is possible that only one object is being printed on one platform and there is more than one printhead. Thus, the single object on the platform can be built by passes under the printheads wherein material is deposited layer by layer by each pass under a printhead, while the height of the platform is adjusted. The term “build rate” may refer to the speed at which apparatus manufactures or builds the three-dimensional object. The build-rate may be varied based on the additive manufacturing material being used, the required resolution of the three-dimensional object being printed, the size of the three-dimensional object, the required solidification or drying steps required by the material and the three-dimensional object, among other things.

For example, FIGS. 5, 6A, and 6B illustrate the additive manufacturing apparatus 100 may include a plurality of print heads 106. The plurality of print heads 106 may be connected to a plurality of reservoirs that contain differing additive manufacturing materials. In some embodiments, each print head 106 may be connected to a plurality of reservoirs that contain differing additive manufacturing materials. Each print head 106 may be configured to operate independently such that the additive manufacturing apparatus 100 may concurrently print the plurality of three-dimensional objects.

Embodiments of the present disclosure provide a plurality of reservoirs for containing a differing additive manufacturing material in each reservoir, and wherein the at least one processor is configured to concurrently print a plurality of three-dimensional objects at differing resolutions using the plurality of the differing additive manufacturing materials. The term “resolution” may refer to the XY resolution, the Z resolution, or both. The XY resolution may also be referred to as the horizontal resolution and may refer to the smallest horizontal movement the additive manufacturing apparatus can make within a single layer. The smaller the horizontal movement the additive manufacturing apparatus can make, the higher the XY resolution. The Z resolution may refer to the vertical resolution or layer thickness the additive manufacturing apparatus is capable of or employs. Similarly, the smaller the layer thickness, the higher the Z resolution. The additive manufacturing apparatus may be configured to concurrently print a plurality of three-dimensional objects at differing resolutions. For example, a first three-dimensional object may be printed at a first resolution while a second three-dimensional object may be printed at a second resolution.

Looking at FIGS. 5, 6A, and 6B, the plurality of print heads 106 may be connected to a plurality of reservoirs that contain differing additive manufacturing materials. In some embodiments, each print head 106 may be connected to a plurality of reservoirs that contain differing additive manufacturing materials. Each print head 106 may be configured to operate independently such that the additive manufacturing apparatus 100 may concurrently print the plurality of three-dimensional objects at differing resolutions.

According to some embodiments, the additive manufacturing apparatus may further include at least two reservoirs for containing a differing additive manufacturing material in each reservoir. The at least one processor is configured to concurrently print a plurality of three-dimensional objects using the differing additive manufacturing materials in a manner such each object is constructed of additive manufacturing materials from a different one of the at least two reservoirs. In a non-limiting example, a first additive manufacturing material may include a carrier liquid and a support material and may be in a first reservoir. The second additive manufacturing material having a carrier liquid and an object material or a second support material that may differ from the first additive manufacturing material may be in a second reservoir. The at least two reservoirs may be in communication with the at least one print head via at least two conduits. In one embodiment, the processor may instruct the at least one print head to print a first layer of the three-dimensional object with the first additive manufacturing material and a second layer of the three-dimensional object with the second additive manufacturing material. In another embodiment, the processor may instruct the at least one print head to print a first portion of a layer of the three-dimensional object with the first additive manufacturing material and a second portion of the same layer with the second additive manufacturing material. In addition, the at least one reservoir communicates with more than one print head. In such an embodiment, the at least one reservoir may be associated with different printing units where the reservoir can communicate an additive manufacturing material to multiple printing units either concurrently or at distinct times.

FIGS. 5, 6A, and 6B show the plurality of print heads 106 may be connected to a plurality of reservoirs that contain differing additive manufacturing materials. In some embodiments, each print head 106 may be connected to a plurality of reservoirs that contain differing additive manufacturing materials. The processor may instruct the at least one print head 106 to print a first layer of the three-dimensional object 400 with a first additive manufacturing material from a first reservoir and a second layer of the three-dimensional object 400 with a second additive manufacturing material from a second reservoir, where the first and second additive manufacturing materials are different.

In other embodiments, additive manufacturing apparatus 100 may be configured with a plurality of printing modules 200 to print multiple materials from multiple reservoirs 110 in one rotation. For example, in a single rotation of rotating tray 206, a first printing module 200 may print a first layer using a first material from the reservoir 110, a second printing module 200 may print a first layer using a second material from a second reservoir, a third printing module 200 may print a first layer using a third material from a third reservoir, a fourth printing module 200 may print a second layer using the first material, a fifth printing module 200 may print a second layer using the second material, a sixth printing module 200 may print a second layer using the third material; and so on.

In some embodiments, the at least one processor may be configured to cause the at least one print head to concurrently print a plurality of three-dimensional objects at different heights. The term “height” may refer to the vertical distance of the printed object or thickness of the object in a vertical direction. The additive manufacturing apparatus may be configured to concurrently print a plurality of three-dimensional objects at differing resolutions. For example, a first three-dimensional object may be printed at a first resolution while a second three-dimensional object may be printed at a second resolution. For example, each print head 106 may be configured to operate independently such that the additive manufacturing apparatus 100 may concurrently print the plurality of three-dimensional objects at different heights. In a non-limiting example, a first printed three-dimensional object may be taller than a second printed three-dimensional object. In that case, when the second printed three-dimensional object (i.e. the shorter object) is completed, the substrate with the second printed object may be removed from the printing table or from the printing platform. This removal allows the object to cool without a prolonged presence of the object in the heated printing cell without being cooled.

In some embodiments, when different substrates are attached on different printing platforms, after removing a substrate with finished parts, a new substrate can be installed on the printing platform. Then the printing platform height may be adjusted so that the upper surface of the substrate is at the same vertical position (i.e. Z-axis level) as the upper surface of the parts on another printing platform or platforms that continue printing. Accordingly, new objects can start building on the new substrate together with the continuation of the other objects already in the building process.

In some embodiments, removing a substrate with finished parts from the table or from the platform, as well as installing a new substrate, changing the height of the platform, and starting printing new object, can be done either by the controller or manually by a printer operator.

According to embodiments of this disclosure, removing a substrate with finished parts from a platform, changing the height of the platform, and starting printing new objects on a new substrate, can resume interchangeably between the different platforms, until the platforms reach a maximum height level above the table.

In another embodiment, when tall objects are printed on one platform (with substrate) and short on another one, the controller may calculate the difference (i.e. ΔZ) between the tall and short heights of the objects. The controller may start printing the tall objects on the one platform (with substrate). When printing the layer of the height ΔZ of the tall objects, the printing platform where the shorter objects are to be printed may be moved vertically to align with the vertical position of the printing platforms of the taller objects actively being printed. The printer may start printing the short objects with the tall ones, so that printing of both finish substantially at the same time (or finish at the same layer). In this case many variations can be implemented, including gradually increasing the height of the platform intended for printing the short objects layer by layer, but never increasing its height so that the upper surface of the substrate on the platform is higher than the upper layer being printed.

In some embodiments, the substrate may include material of high heat conductance to enable sufficient heat flow from below to the printed objects. Alternatively, the substrate may be sufficiently thin to allow sufficient heat to flow from below the printed objects. Alternatively, the substrate may include material of particularly low heat conductance. In that case, the printed objects primarily receive heat from above, layer by layer.

Embodiments of the additive manufacturing apparatus according to the present disclosure further include a plurality of print heads, the at least one processor is configured to concurrently print a plurality of three-dimensional objects such that when at least one of the plurality of print heads is actively printing objects, another of the plurality of print heads are inactive. The term “actively printing objects” may refer to print heads that are depositing additive manufacturing material while the term “inactive” refers to print heads that are not depositing additive manufacturing material. The print heads may transition from an active state to an inactive state and from an inactive state to an active state as needed. In a non-limiting example, a first print head may be actively printing a first object while a second print head is inactive. Once the first print head has completed a layer of the first object, the first print head may transition to being inactive and the second print head may rotate into position to transition to an active state where the second print head may print a layer of the object.

In some embodiments, additive manufacturing apparatus 100 may be configured with a plurality of printing modules 200 to print multiple materials from multiple reservoirs 110 in one rotation. For example, in a single rotation of rotating tray 206, a first printing module 200 may be in an active state and print a first layer using a first material from the reservoir 110, while a second printing module 200 is inactive. The first printing module 200 may transition to an inactive state and a second printing module 200 may transition to an active state and print a first layer using a second material from a second reservoir. Furthermore, a third printing module 200 may transition to an active state and print a first layer using a third material from a third reservoir when the second printing module 200 transitions to an inactive state, and so on.

In some embodiments, the at least one processor is configured to concurrently print three-dimensional objects on different printing platforms such that printing of at least one object is completed before the printing of at least one other object is completed. A first three-dimensional object may be printed to completion on a first printing platform before the additive manufacturing apparatus rotates to print a second three-dimensional object on a second printing platform. For example, in a single rotation of rotating tray 206, a first printing module 200 may print a first layer using a first material from the reservoir 110, a second printing module 200 may print a first layer using a second material from a second reservoir, a third printing module 200 may print a first layer using a third material from a third reservoir, a fourth printing module 200 may print a second layer using the first material, a fifth printing module 200 may print a second layer using the second material, a sixth printing module 200 may print a second layer using the third material; and so on until the first three-dimensional object is complete. The process may repeat for a second three-dimensional object until the second three-dimensional object is complete, and so on.

According to some embodiments, further comprising at least one heating device configured to control the temperature of multiple objects printed on different platforms in order to solidify the objects. The heating device may be a dryer that may include heating elements, electromagnetic (EM) radiating lamps, ultraviolet (UV) heat source, hot air blowers, infrared (IR) radiation lamps, microwave generator(s), and/or diodes. The heating device may control the temperature, and the controlled temperature may provide solidification of the printed objects. In some embodiments, different EM heating elements differ from each other by the emitted spectral range (i.e. wavelength range). The controller can control the intensity of the heaters, i.e. the intensity of the radiated or blown energy. The term “solidify” may refer to the drying process where the printed object transforms from malleable layers into a solid three-dimensional object as desired.

According to some embodiments and with reference to FIG. 3, additive manufacturing apparatus 100 may include at least one solidifying module 202 to assist the solidifying process of an article being printed. At least one solidifying module 202 may be installed above a printing table 204 on which the articles are produced by 3D printing. In one embodiment, every printing module 200 may be followed by solidifying module 202. In one embodiment, each printing module 200 may be associated with a corresponding solidifying module 202. In one embodiment, solidifying module 202 may be selected in accordance with the support and/or printing materials used by the associated printing module 200. Additionally, solidifying module 202 may be located between 1 mm to 5 mm above the printing surface and may include one or more heat sources 112 facilitating the desired solidification effect on the support and/or printing materials. Consistent with disclosed embodiment, heat sources 112 may include, for example, heating elements, electromagnetic (EM) radiating lamps, hot air blowers, I.R. radiation lamps, and/or diodes.

In some embodiments, the at least one print head includes a plurality of print heads arranged in at least one of a rotational axis (often also notated as tangential or angular axis) and a radial axis. The at least one print head includes a plurality of print heads and each print head includes linear array of nozzles substantially arranged in the radial direction. A single printing module (also notated as printing unit) may include 1, 2 or more print heads located roughly one after the other in the tangential direction of the tray. In some embodiments, it may be desired that the print heads cover the entire radial width of the ring shape table shown in FIG. 2. Accordingly, the orifice array formed by the plurality of print heads would extend at least from the small radius of the ring up to the large radius. According to one embodiment, the complete nozzle array may be composed of a plurality of array segments brought about by the plurality of print heads disposed and extend from the short radius to the large radius. In FIG. 3, for example, 3 heads are required for covering the entire radial range. Thus, according to one embodiment, the print heads in a printing module may be disposed one after the other in the radial direction. Since the body of a head may be longer than the nozzle array, and it is desired to prevent recesses between the plural nozzle arrays in the radial direction, a second head may be located in a staggered fashion in respect to a first head. The first nozzle of the second head (the nozzle closer to the center of the table falls at substantially the same distance (radius) from the center of the table rotation as the last nozzle in a first head. During printing, the printer controller may synchronize and seam the different nozzle arrays (or segments) to an equivalent one long array extending over the entire width of the table ring. In the case of two or more print heads one after the other in the angular direction, the heads can be positioned with a slight shift from one another in the radial direction R (stagger shift). Such shift can effectively reduce the radial space (ΔR step) between adjacent nozzles (in the radial direction) of a printing module by a factor of 2, 3, 4 . . . with 2 or 3 or 4 . . . heads one after the other, in respect to the space between nozzle of a single head. According to some embodiments, the at least one print head includes a plurality of print heads associated with a plurality of printing units and wherein the plurality of printing units are arranged with a differing radial distance and print heads in each printing unit are arranged parallel to each other.

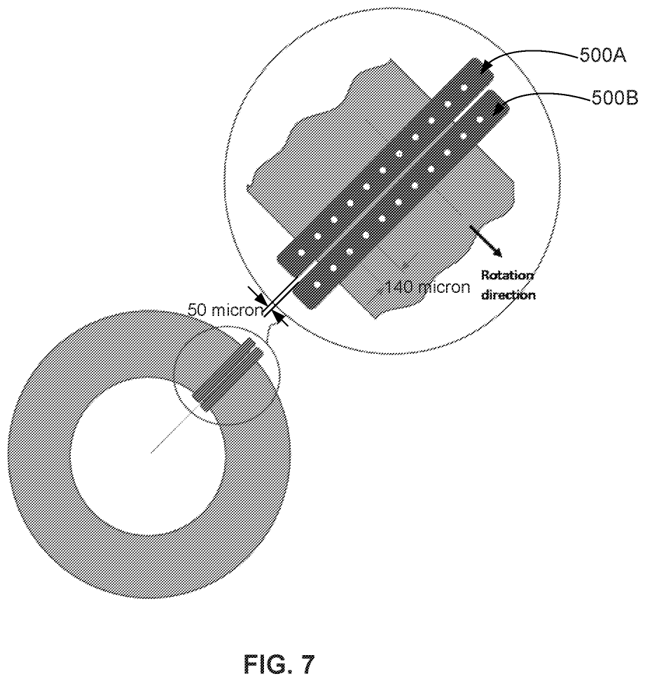

FIG. 7 is a diagrammatic illustration of two print heads (500A and 500B) in a single printing module 200. Consistent with present disclosure, a single printing module 200 may include 1, 2 or more print heads 500 located roughly one after the other in the tangential direction of the tray. According to one embodiment, the print heads in printing module 200 may be separated radially. In addition, in order to effectively reduce the radial separation between all adjacent nozzles (in the radial direction) of a printing module, a second head is located in a staggered fashion in respect to a first head (as illustrated in FIG. 3), e.g. its nozzles fall at the center (in the radial direction) of adjacent nozzles in a first head, so to multiply the printing resolution. In the case of thee print heads one after the other, the stagger can effectively reduce the radial separation between all adjacent nozzles (in the radial direction) of a printing module by a factor of between 1.5 to 4.5, for example by a factor of 3.

In the example of FIG. 7, the distance between two adjacent nozzles in one head (500A or 500B) is 140 micron (in the radial direction). As depicted in FIG. 7, the distance between the two print heads in the tangential direction is 50 micron. Head 500B is located shifted in the radial direction from head 500A by 70 micron, so to achieve the desired multiplication of the resolution in the radial direction (staggered configuration).

In some embodiments, the at least one print head includes a plurality of print heads and wherein each print head is shielded from heat and fumes by a cooled mask, wherein jetting is performed through slits in the mask. Each print head may be shielded by a heat shield. The term “heat shield” may refer to a plate that at least partially covers the nozzles array and has an opening to facilitate printing from nozzles to the printing area. The heat shield may be outside the printing table and may be configured to be maintained at a constant height from the at least one print head. The heat shield may include at least one of: thermal insulator, thermal radiation reflector. The radiation reflector may reflect thermal radiation (and optionally E.M. heating radiation) back to the printing area. When the table is of ring shape, a shield can be located also inside the ring.

For example, with reference to FIG. 1, additive manufacturing apparatus 100 may also include a thermal buffer, such as heat shield 116. Because the printed object is relatively hot (e.g., about 230° C.) as compared to room temperature (e.g., about 25° C.), print head 106 should be protected from the heat and fumes emerging from the printing area. In one embodiment, heat shield 116 may be maintained at a relatively low temperature compared to the temperature of the object while being printed (e.g., from 10 to 40° C.) to provide a thermal barrier between the print head 106 and the printed object.

In some embodiments, the additive manufacturing apparatus may further include a maintenance station positioned on a height-controlled platform on the printing table and maintained at constant height relative to the at least one print head. The maintenance station may include a wiper configured to wipe a mask bottom from accumulated condensed fumes, and inspection substrate to periodically test the jetting performance In some embodiments, the wiper is disposed at a constant level below the at least one print head. The wiper may be located at one of: on the maintenance station, outside the rotating table, or included in a printing unit. The wiper may be a roller, one or more blades, or any other structure that can remove undesirable material that accumulated on the mask.

The wiper may wipe the masks' bottom every printing revolution or every second revolution, every third revolution, etc. Therefore, the wiper may have On and Off states, where at On state the wiper wiping edge touches the mask, and at Off state the edge is controlled to be lower than the mask bottom. The wiper may also be located at one of: on the maintenance station, outside the rotating table, or included in a printing unit. When the wiper is located on the rotating table, the wiper may wipe the mask in a rotation direction. When located outside the table and/or included in a printing unit, the wiper may be controlled to wipe the mask in a radial direction (a direction substantially parallel to the jetting slit in the mask, and thus the possibility that the wiped fume enters the slits is reduced). The wiper may include a resilient material, e.g. silicon rubber.

The printing apparatus may include a wiper for the print head to wipe a surface of the print head (e.g. the orifice or the nozzle surface). Wiping may be performed through the slit in the mask in radial direction along the nozzle array behind the slit. The head apparatus is located one of: the maintenance station, outside the rotating table, or included in a printing unit. The print head may be in an inactive state throughout the wiping process such that the print head being wiped is not jetting. The rotation stops throughout wiping when the wiper is located on the rotating maintenance station. The rotation mechanism can be used to position the maintenance station under the chosen printing unit to be wiped. When the wiper is included in a printing unit, wiping can be done even without stopping rotation when no printed objects area passes under the wiped head or printing unit (e.g. the maintenance station). In this case, each printing unit comprises its own heads' wiper.

The printing assembly may also include a fume suction system to remove the part of the fume that does not condense at the bottom of the mask from the printing area. Removal the fumes may assist the drying process of the printed parts. Fume suction system may comprise a pump, sucking nozzles or slits, waste tank, and communicating piping. The sucking nozzles may be located after each heating element in the printing assembly or after each printing unit.

The maintenance procedure for the print heads may include repeating ink purge cycles. When the print heads are shielded by a mask from the hot substrate and hot layer below, the purged ink may be sucked back to the ink reservoir by a vacuum in the gap between the orifice plate and the mask bottom. This process may be accompanied by air entering the mask through the open slit, and purging above the hot substrate should be prevented to prevent heating the orifice plate and drying the ink in the orifice apertures. Thus, purging is done in one of the following ways: at above the maintenance station (which is kept cool), at outside from above the table. Accordingly, for executing purging, the head or the printing unit shifts outside from its printing location.

In some embodiments, the printing unit can be removed or added to the printing assembly. Thus, a printing unit can be removed for maintenance needs and the printer may be able to continue printing with the remaining printing units. If a printing unit is removed, the printer may operate at a smaller table rotation speed. In addition, the printer can be equipped with a certain number of printing units, and later be upgraded with added units.

According to additional embodiments, additive manufacturing apparatus 100 may include a scrubber (not shown) for wiping the printing surface of the printing heads. In addition, the plurality of printing heads in each printing module 200 may be protected by a mask 610, optionally equipped with a wiper for removing condensed liquid accumulated on the bottom surface of the mask.

According to some embodiments of the present disclosure, the additive manufacturing apparatus may further include a uniform heater that uniformly heats the printing table. The uniform heater may be maintained at a constant distance below the printing table and not rotating with the printing table. In some exemplary embodiments, the uniform heater is configured to heat the table by electromagnetic (EM) radiation. In some embodiments, the uniform heater may heat the table by blowing hot air, by conduction through air layer, or through elastic material that touches the rotating table.

In some embodiments, where one or more platforms are installed on the table, each platform includes a heater that uniformly heats the substrate attached on or built in the platform. In that case the different substrates can be heated to different temperatures, which may be required when printing objects of different materials.

Additive manufacturing apparatus 100 may be configured to keep removable substrate 300 at high temperature (e.g., between 140° C. to 275° C., between 200° C. to 300° C., or between 200° C. to 450° C.). As discussed above, the heating of removable substrates 300 may take place in one or more ways. In one example, additive manufacturing apparatus 100 may include heating elements 406 that are attached to rotating tray 206 that holds substrates 300. In another example, additive manufacturing apparatus 100 may include a non-rotating heating assembly 406 (e.g., EM radiating lamps) that may be closely separated from rotating tray 206. Heating assembly 406 may move in the Z axis direction to keep a constant distance from rotating tray 206. In one example, additive manufacturing apparatus 100 may use heating assembly 408 to warm substrate 300 before and/or during printing. In addition, substrates 300 may have low thermal capacity and low thermal conductivity. In another example, additive manufacturing apparatus 100 may include a non-rotating heating assembly 410 that is stationary in the Z axis direction, and the space from rotating tray 206 varies along the printing session.

In addition, thermal insulating and radiation reflective walls 412-414 may be used to efficiently guide heat to rotating tray 206. In one example, reflective walls 412 may be associated with each printing module 200. In another example, reflective walls 412 may have a cylindrical shaped insulation and be designed to cover all of printing table 204. In some embodiments, thermally insulating walls and radiation reflective walls 412-414 (inside and/or outside rotating tray 206), may be kept at a predetermined height from the printing heads. Thermally insulating walls and radiation reflective walls 412-414 may rotate with rotating tray 206, or not. In addition, thermally insulating walls 412 may include a reflective surface 414 that is optically reflective both in infrared (I.R.) and visible spectral ranges. This way, thermally insulating and reflective walls 412-414 may reflect back radiated heat from the warm objects and heating radiation from heating elements above and/or below the rotating tray 206.

In some embodiments, additive manufacturing apparatus 100 may also include an imager, such as image sensor 128. The term “imager” or “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 128 may be part of a camera configured to capture the printing region.

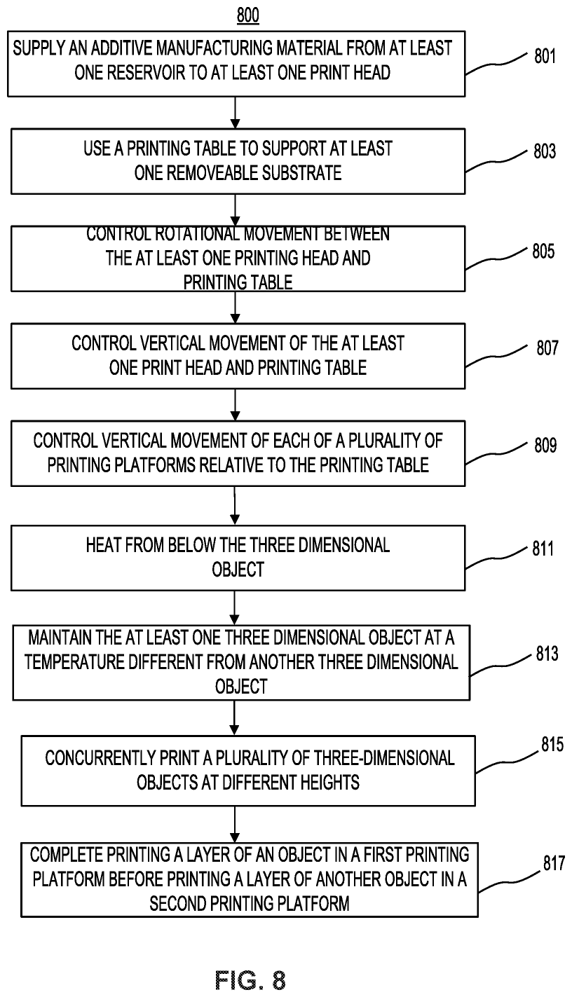

According to embodiments of the present disclosure, a printing method is disclosed. The printing method may include supplying an additive manufacturing material in a fluid from at least one reservoir to at least one print head, wherein the at least one print head is configured to deposit the additive manufacturing material. The printing method may print more than one type of additive manufacturing material. As described above, additive manufacturing material includes any fluid intended for deposition on a printing surface in a desired pattern. The term “additive manufacturing material” is also known as “printing material,” “printing liquid,” and “ink.” As described above, the at least one print head may include a plurality of nozzles organized in a linear array or plate and may be generally manufactured together as one. The reservoir may be in communication with the at least one print head via a conduit. The at least one print head may be configured to deposit the fluidic additive manufacturing material layer by layer. FIG. 8 shows a printing method 800 that supplies an additive manufacturing material from at least one reservoir to at least one print head at step 801. According to some embodiments, the printing method 800 may be employed using additive manufacturing apparatus 100 as described above.

In some embodiments, the printing method further includes using a printing table including at least one printing region for supporting at least one removable substrate for printing at least one three-dimensional object. The printing table may be a table or surface that supports the one or more removeable substrates. The printing region may include an area with any rigid surface capable of holding multiple layers of material dispensed from additive manufacturing apparatus. The removeable substrate may refer to the base material on which each object is printed, and on each substrate one or more objects can be simultaneously printed. The removable substrate may be attached to the printing table using vacuum, an adhesive, a tray, or any suitable structure for removably attaching the substrate to the printing table. The at least one removable substrate may be made from a material other than the additive manufacturing material. In a non-limiting example, the removable substrate may be made from aluminum covered with nickel. FIG. 8 shows printing method 800 includes step 803 that uses a printing table to support at least one removeable substrate.

In some embodiments, the printing method includes controlling a rotational movement between the at least one printing head and a printing table and controlling a vertical movement of the at least one print head relative to the printing table. The printing method may control the rotational movement between the at least one print head and the printing table. For example, at least one processor may instruct the at least one print head to rotate with respect to the printing table. In another example, the at least one processor may instruct the printing table to rotate with respect to the at least one print head. The method may control the vertical movement between the at least one print head and the printing table. For example, at least one processor may instruct the at least one print head to move vertically (i.e. in the Z direction) with respect to the printing table. In another example, the at least one processor may instruct the printing table to move vertically with respect to the at least one print head. FIG. 8 shows printing method 800 includes step 805 that controls the rotational movement between the at least one printing head and the printing table and step 807 that controls the vertical movement of the at least on print head and the printing table.

According to some embodiments, the printing table includes at least one independently movable printing platform on the printing table for supporting the at least one three-dimensional object. The printing platform may also be referred to as a stage, a support, or a stand, that may be individually controllable in the vertical direction. The at least one printing platform may support the at least one three-dimensional object to be printed on the at least one printing platform. The at least one printing platform may be connected to the printing table and may be positioned between the printing table and the removeable substrate. As such, the at least one printing platform may support the removeable substrate and the three-dimensional object. The at least one moveable platform may be moveable in a vertical direction (i.e. Z-axis) relative to the printing table and the at least one print head.

In some embodiments, the at least one printing platform includes a plurality of printing platforms individually moveable in a vertical direction relative to the printing table. A round printing configuration may be used to increase production throughput. The round printing configuration may be used with a continuous rotation between the print heads system and a printing tray, along with gradual increase of Z (vertical motion) separation between both, so that the printed layer is at constant Z distance from the print heads. The printing platforms may be arranged around the round printing configuration at a common radial distance from a center of the printing table. The “common radial distance” may refer to the distance from each printing platform to a center point of the printing table or tray. Each printing platform positioned at the common radial distance from the center of the printing table may create a circular pattern of printing platforms around the round printing tray.

The method may further include controlling a vertical movement of each of the plurality of printing platforms relative to the printing table and controlling an additional vertical movement of at least one of the printing table and the frame. The printing method may individually control the vertical movement of the at least one moveable printing platform. Additionally, the printing method may control the vertical movement between the printing table and the frame holding the at least one print head. For example, the at least one processor may instruct the at least one print head to move vertically (i.e. in the Z direction) with respect to the printing table, and the processor may instruct the at least one moveable printing platform to move vertically. The printing method 800 may also include step 809 that controls a vertical movement of each of a plurality of printing platforms relative to the printing table.

According to some embodiments, the printing method may further include heating from below the at least one three-dimensional object during the additive manufacturing process. Heating the three-dimensional object may utilize a heating element that may include any device configured to supply heat to the three-dimensional object. The heating element may be a heat source, electromagnetic (EM) radiating lamps, hot air blowers, I.R. radiation lamps, and/or diodes. The heating element may be connected to the printing platform below the three-dimensional object to supply heat from below the thee-dimensional object. The printing method 800 may also include step 811 that heats from below the three-dimensional object.

Consistent with the present disclosure, the printing method may further include maintaining the at least one the three-dimensional product at a temperature different from at least another three-dimensional product. In some embodiments, the method may cause the at least one three-dimensional object to be maintained at a temperature higher than the temperature of another three-dimensional object. In other embodiments, the processor may store instructions that cause the at least one three-dimensional object to be maintained at a temperature lower than another of the three-dimensional products. The at least one processor may maintain three-dimensional objects at different temperatures due to differing materials, differing build rates, differing resolutions, among other things. The printing method 800 may also include step 813 that maintains the at least one three-dimensional object at a temperature different from another three-dimensional object.

In some embodiments, the printing method may further include causing the at least of print head to concurrently print a plurality of three-dimensional objects at different heights. Height may refer to the vertical distance of the printed object or thickness of the object in a vertical direction. The printing method may be configured to concurrently print a plurality of three-dimensional objects at differing resolutions. For example, a first three-dimensional object may be printed at a first resolution while a second three-dimensional object may be printed at a second resolution. For example, each print head 106 may be configured to operate independently such that the additive manufacturing apparatus 100 may concurrently print the plurality of three-dimensional objects at different heights. In a non-limiting example, a first printed three-dimensional object may be taller than a second printed three-dimensional object. The printing method 800 may also include step 815 that concurrently prints a plurality of three-dimensional objects at different heights.

In some embodiments, the printing method further includes concurrently printing a plurality of three-dimensional objects such that printing of a layer of an object in a first printing platform is completed before the printing of a layer of another object in a second printing platform. A layer of a first three-dimensional object may be printed to completion on a first printing platform before the additive manufacturing apparatus rotates to print a layer of a second three-dimensional object on a second printing platform. For example, in a single rotation of rotating tray 206, a first printing module 200 may print a first layer of a first three-dimensional object using a first material from the reservoir 110. When the first layer of the first three-dimensional object is complete, the printing module may rotate to print a first layer of a second three-dimensional object. The process may repeat for a second layer of each three-dimensional object until the second layer of each three-dimensional object is complete, and so on. The printing method 800 may also include step 817 that completes printing a layer of an object in a first printing platform before printing a layer of another object in a second printing platform.

Consistent with the present disclosure, after the printing process has been completed, the object may be placed in a furnace for sintering. In some embodiments, the object may be fired in the furnace to a predetermined temperature until complete sintering occurs. The sintering process can include the following firing steps:
Initial warming to burn out all organic material;
Additional warming to liquidize inorganic additives, such as, Cobalt, if included in the additive manufacturing material; and
Final warming to sinter the particles.
   Some of the firing steps can include applying vacuum, applying pressure, adding inert gas to prevent oxidation, and adding other gases that may add desired molecular diffusion or chemical reaction with the body.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, e.g., hard disks or CD ROM, or other forms of RAM or ROM, USB media, DVD, Blu-ray, Ultra HD Blu-ray, or other optical drive media.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. Additionally, the recitations of “at least one” may include a single element or a plurality of elements. For example, at least one frame print head may include a single print head or a plurality of print heads, at least one reservoir may include a single reservoir or a plurality of reservoirs, at least one platform may include a single platform or a plurality of platforms, etc. The examples are to be construed as non-exclusive. Furthermore, the steps of the disclosed methods may be modified in any manner, including by reordering steps and/or inserting or deleting steps. It is intended, therefore, that the specification and examples be considered as illustrative only.

1-34. (canceled)

35. An additive manufacturing apparatus, comprising:
at least one frame for supporting at least one print head configured to deposit fluidic additive manufacturing material deposition layer by deposition layer;
at least one reservoir in communication with the at least one print head, the at least one reservoir being configured to contain the fluidic additive manufacturing material;
a printing table configured to support at least one movable printing platform and at least one removable substrate thereon for printing at least two three-dimensional objects; and
at least one processor configured to:
control horizontal movement between the at least one print head and the printing table;
control vertical movement between the at least one print head and the printing table; and
control at least one vertical movement of the at least one movable printing platform relative to the printing table.

36. The additive manufacturing apparatus of claim 35, wherein the at least one movable printing platform includes heating elements for heating from below the at least one removable substrate during an additive manufacturing process.

37. The additive manufacturing apparatus of claim 35, wherein the printing table has a round shape and is rotatable about a rotation axis at the center of the printing table.

38. The additive manufacturing apparatus of claim 35, further comprising at least one grinder for leveling deposited material added to the at least two three-dimensional objects between depositing the deposition layers in an additive manufacturing process.

39. The additive manufacturing apparatus of claim 35, further comprising at least two reservoirs for containing a differing additive manufacturing material in each reservoir, wherein the at least one processor is configured to print the at least two three-dimensional objects using a plurality of the differing additive manufacturing materials.

40. The additive manufacturing apparatus according to claim 39, wherein the at least one processor is configured to concurrently print the at least two three-dimensional objects at a common build rate using the differing additive manufacturing materials.

41. The additive manufacturing apparatus of claim 35, wherein the at least one movable printing platform includes a plurality of individually printing platforms movable to different platform heights and wherein the at least one processor is configured to cause the at least one print head to concurrently print the at least two three-dimensional objects at the different platform heights.

42. The additive manufacturing apparatus of claim 35, wherein the at least one print head includes a plurality of print heads and wherein the at least one processor is configured to concurrently print the at least two three-dimensional objects such that when at least one of the plurality of print heads is actively printing, another of the plurality of print heads is inactive.

43. The apparatus of claim 42, wherein each of the plurality of print heads undergoes scrubbing while the print head is in an inactive state.

44. The additive manufacturing apparatus of claim 35, wherein the at least one processor is configured to concurrently print the at least two three-dimensional objects on different ones of the movable printing platforms such that printing of one of the three-dimensional objects on one of the movable printing platforms is completed before the printing of another one of the three-dimensional objects on another one of the movable printing platforms.

45. The additive manufacturing apparatus of claim 37, wherein the apparatus has a round printing configuration and the at least one print head includes a plurality of print heads arranged around at least one of a tangential axis and a radial axis.

46. The additive manufacturing apparatus of claim 45, wherein the plurality of print heads are associated with a plurality of printing units, wherein the plurality of printing units are respectively arranged with differing radial distances from the center of the printing table, and wherein the print heads in each of the plurality of printing units are arranged parallel to each other.

47. The additive manufacturing apparatus of claim 35, further comprising a maintenance station positioned on a height-controlled platform on the printing table that is maintained at a constant height relative to the at least one print head, wherein the maintenance station includes a wiper configured to wipe accumulated condensed fumes from a mask bottom, and wherein the maintenance station includes an inspection substrate to periodically test a jetting performance.

48. The additive manufacturing apparatus according to claim 35, further comprising a uniform heater that uniformly heats the printing table.

49. The additive manufacturing apparatus according to claim 35, further comprising a heat source that is at least one of: a halogen lamp, I.R. lamp, UV lamp, a laser, a flash-lamp, or a microwave source, to directly heat a printed layer by radiation from above.

50. A printing method, comprising:
supplying an additive manufacturing material in a fluid from at least one reservoir to at least one print head, wherein the at least one print head is configured to deposit the additive manufacturing material;
using a printing table including at least one printing region for supporting at least one removable substrate for printing at least one three-dimensional object, wherein the at least one removable substrate is made from a material other than the additive manufacturing material;
controlling a rotational movement between the at least one print head and the printing table; and
controlling a vertical movement of the at least one print head relative to the printing table.

51. The method of claim 50, wherein the printing table includes at least one independently movable printing platform on the printing table for supporting the at least one three-dimensional object.

52. The method of claim 51, wherein the at least one independently movable printing platform includes a plurality of printing platforms individually movable in a vertical direction relative to the printing table, the method further comprising:
controlling a vertical movement of each of the plurality of printing platforms relative to the printing table, and
controlling an additional vertical movement of at least one of the printing table and at least one frame.

53. The method according to claim 50, further comprising heating from below the at least one three-dimensional object during an additive manufacturing process.

54. The method according to claim 50, further comprising causing the at least one print head to concurrently print a plurality of three-dimensional objects at different heights.
